(19) United States
(12) Patent Application Publication
(10) Pub. No.: US 2013/0233242 A1
(43) Pub. Date: Sep. 12, 2013

(54) APPLICATION TOOL

(71) Applicant: Juergen Feuerstein, Lahr (DE)

(72) Inventor: Juergen Feuerstein, Lahr (DE)

(21) Appl. No.: 13/593,817

(22) Filed: Aug. 24, 2012

(30) Foreign Application Priority Data
Mar. 6, 2012 (EP) 12001510.2

(51) Int. Cl. B05C 1/00

(52) U.S. Cl. 118/200

(57) ABSTRACT

An application tool for applying a coating material on a substrate surface. The tool has a shaft for gripping and a reservoir accommodated in the shaft for stocking with coating material. The tool has a tool head having an applicator, by which the coating material passes onto the surface, and a valve is arranged between the reservoir and the tool head, which, when actuated, changes from a closed into an open position to output coating material onto the applicator for application onto the surface. In order to reduce consumption and allow for refilling with a coating material in a reliable and clean manner, a carrier part, on which the valve is secured with its valve body, is arranged between the shaft and the tool head of the application tool, and the carrier part is detachably connectable in each case to the shaft and to the tool head of the tool.

### CROSS-REFERENCE TO RELATED APPLICATIONS

This application claims the benefit of European Patent Application No. 12 001 510.2, filed Mar. 6, 2012, which is incorporated herein by reference as if fully set forth.

### BACKGROUND

The invention relates to an application tool for applying a coating material on a substrate surface, said tool having a shaft by which the tool can be gripped and having a reservoir accommodated in the shaft for stocking up with the coating material, wherein the tool is provided with a tool head having an applicator, by which the coating material passes onto the surface, and having a valve which is arranged between the reservoir and the tool head, and which, when actuated, changes from a closed into an open position and in this latter, outputs a quantity of coating material onto the applicator for application onto the surface.

These types of application tools for applying a protective, decorative, or functional layer are definitely known and can be realized, for example, in the manner of a pen so that they are particularly simple to handle, differently formed applicators making quite different methods of application possible. Common to the various applications, for example, can be that the operator exerting a certain pressure via the shaft onto the applicator or a part connected thereto triggers the valve actuation, which brings about the release of the coating material out of the reservoir. For example, these types of application tools can be realized, for instance, as so-called pump markers in pen form in the growing, so-called “Fine Art” area in the sector of decorative coatings. As well as this, the application tools in general and their reservoirs can also be provided with other vessels which are closable, for instance, by means of connections to be screwed or plugged-in.

Once its reservoir has been emptied, the application tool can be supplied to a waste disposal process, which can be relatively quick in the case of correspondingly intensive use or a limited reservoir. In order to avoid this, it has already been proposed, on the one hand, to refill the reservoir of the application tool via a closable opening in the rear region, in particular on a bottom surface of the application tool. In the majority of cases this is awkward and as a result of tool instability in the upright state, which is present in the majority of cases, is not a particularly satisfactory solution, as during refilling there must always be the fear of the tool falling over with corresponding contamination in the surrounding area caused by the coating material. Just as awkward and less practical because it makes production of the application tool massively more expensive, appears the proposal of placing the tool on its base remote from the tool head and removing the valve held in an opening of the reservoir for refilling. In order to make a minimum amount of stability available for said operation, the base region of the tool would have to be widened, where applicable, in a disproportionate manner compared to its other dimensions, on the other hand removing and re-applying the valve in a contamination-free manner is only successful extremely rarely.

### SUMMARY

Consequently, the object is to make available an application tool which, on the one hand, reduces the consumption of application tools per se and, on the other hand, allows them to be refilled with a coating material in a reliable and clean manner.

This object is achieved by an application tool of the aformentioned type, where a carrier part, on which the valve is secured with its valve body, is arranged between the shaft and the tool head of the application tool and the carrier part is provided so as to be detachably connectable in each case to the shaft and to the tool head of the tool. The carrier part can accordingly accommodate the valve of the application tool, as a result of which said valve can be prepared in a simple manner for a filling or re-filling with the respective coating material without there being any fear that this would be linked to unintentional contamination of the surrounding area. At the same time, the reservoir size and the consumption of the respective amount of coating material held in the reservoir of the application tool are no longer the criteria which establish the end of its use when the tool is used, such that a not inconsiderable contribution to reducing the amount of waste is accomplished, which seems definitely notable from an environmental aspect. A definitely notable secondary effect which emphasizes sustainability, in this connection, is that the fill amount of the reservoir is expanded by the volume enclosed by the carrier part during its use.

An embodiment of the application tool which can be handled easily during the refilling operation can be formed in that the carrier part is formed by a sleeve which accommodates the valve body at least over part of its longitudinal extension, in particular accommodates the predominant part of the longitudinal extension of the valve body. As the relevant sleeve encloses the valve or its body, it can be gripped in an advantageous manner without the relevant person coming into contact with the coating material at the same time.

In the case of a further advantageous configuration of the application tool, the valve body forms a rotational body which is invariant about its longitudinal axis under arbitrary rotational operations and is provided with an annular flange which covers the opening edge of one end of the carrier part in the operating position of the valve body such that an end-side closure of the carrier part, which can close the reservoir of the shaft, is formed by the flange and the valve on the relevant end of the carrier part. In the case of a corresponding edge-side configuration of the flange itself, the flange can also be closed off in an advantageously flush manner with the outside of the side wall of the carrier part, as a result of which its contour is continued.

An embodiment of the application tool which is favorable to produce can be provided in that the valve is held on the carrier part by a fixing means, wherein in particular a region of an outer side wall of the valve body forms a driving fit with an inner side wall of the carrier part.

An embodiment of the application tool which is simple to handle can provide, on the ends of the carrier part facing the tool head and the shaft of the application tool, in each case a connecting means, in particular can provide the two connecting means in the same manner, such that said parts of the application tool are able to be taken apart and connected together again simply and rapidly.

The connection between the shaft and the carrier part and the tool head and the carrier part, in the case of a preferred configuration of the application tool, can be realized in a simple manner with, in particular, the same connection such that the carrier part has a region with an internal thread and a region with an external thread along its longitudinal extension. Obviously, however, other types of connections can also be used, such as for example snap-type or latching-type connections which allow for simple assembly or disassembly.

In the case of a particularly preferred configuration of the application tool, to obtain a uniform outer contour of the application tool in continuation of the contour of the shaft and taking on its cross section, the external thread can be provided on an offset of the outer wall of the carrier part, as a result of which, with the tool head arranged on the carrier part, a substantially projection-free and offset-free contour can be realized in the region of the shaft and its extension in the direction of the tool head of the application tool. The region of the outer wall of the carrier part provided with the internal thread, in this connection, can continue the outer wall of the shaft and is itself once again continued by the outer wall of the region of the tool head of the application tool provided with an internal thread, which engages over the external thread of the carrier part in the operating position.

A further development of the application tool which favors the production of the tool also with regard to mold making can be provided with a shaft which has a substantially constant, circular cross section over its longitudinal extension. However, the cross section of the application tool itself can be modified in a continuous or sudden manner in the case of further configurations.

In a preferred manner, however, in the case of a further configuration of the application tool, the shaft, the carrier part and the region of the tool head facing said carrier part joined together form a substantially cylindrical contour in the operating position, as a result of which, in particular, a plurality of tools can be stowed and transported particularly well and in a space saving manner.

In the case of an advantageous configuration of the application tool as claimed in the invention, the shaft of the application tool can be provided from a deflection resistant material such that when the shaft is gripped, a pressure, which is high enough to actuate the valve, can be transferred anyway to the tool head and its applicator can be guided securely on the surface to be painted. The shaft can be provided for this purpose from a metallic or a plastic material. The material of the shaft, moreover, in a further configuration can also be realized either in a transparent manner or in any case can be opaque in such a manner that the coating material stands out against the shaft material and allows the fill level to be observed. Another configuration can provide a transparent or opaque window or a similar recess on the shaft of the tool for this purpose.

In order to be able to output an increased quantity of coating material when coating the relevant surface, an expedient further development of the application tool can be provided in that the shaft of the application tool is provided so as to be elastic at least in regions in such a manner that it is temporarily deformable by a manually applied pressing force, which squeezes the shaft within certain limits. An elasticity of this type can be achieved, for example, by a plastic material provided for this purpose or in a more general manner by a material weakening over a region of the shaft length.

In order to be able to distribute the coating material well, in particular in the decorative area, for example as a coat of paint, on the relevant substrate surface using the application tool and at the same time to be able to realize the creation of a covering, continuous, solid film of coating material in a particularly effective manner, in the case of a further advantageous configuration of the application tool as claimed in the invention, the coating material is provided as a physically drying paint, such that through extensively residue-free evaporation of the solvent of the coating material, a negative influence of the binding agent on the applied coating material can be ruled out. In this case, in a preferred manner these are coating materials with polymer dispersions as binding agents which are capable of forming a continuous film when the solvent is evaporated. In a particularly preferred manner, the coating material can be a paint with an acrylic base. However, other coating materials, which form a preferably continuous, covering film on the surface by drying, can also be applied onto the relevant surface using the application tool.

In order to be able to vary the application of the coating material in particular with regard to quantity and stroke strength when using the same application tool, but also in order, once the consumption limit of the applicator has been reached, to be able to exchange said applicator for a similar-type and similar-value replacement part in a simple manner, in the case of an expedient further development of the application tool, the applicator of the tool head can be provided so as to be replaceable.

With another further development where the applicator of the application tool is protected against unintentional damage or drying out when not in use, the application tool can be provided in the region of its tool head when not in use with a protective cap which, for example, is to be placed onto the tool head or is to be screw-connected to said tool head.

The aforementioned object is also achieved, moreover, by a carrier part for use with an application tool for applying a coating material on a substrate surface, in particular an above-described application tool. It is even possible, namely, to retrofit already used application tools with the mentioned carrier part, it being possible in this connection for the used valve to be used again or, however, to be replaced by a replacement valve.

### BRIEF DESCRIPTION OF THE DRAWINGS

The invention is described below in more detail by way of exemplary embodiments in the drawing. In this connection, in partly schematic representations:

FIG. 1 shows a two-dimensional side view of a first exemplary embodiment of an application tool from the prior art with a tool head arranged on the shaft and an associated protective cap, not placed in position;

FIG. 2 shows a two-dimensional side view of the application tool from FIG. 1 with the tool head removed from the shaft without a protective cap;

FIG. 3 shows a two-dimensional side view of an exemplary embodiment of an application tool as claimed in the invention with a carrier part which is arranged between the shaft and the tool head and carries the valve; and

FIG. 4 shows an exploded representation of a two-dimensional side view of the application tool from FIG. 3 with shaft, carrier part, valve and tool head.

### DETAILED DESCRIPTION OF THE PREFERRED EMBODIMENT

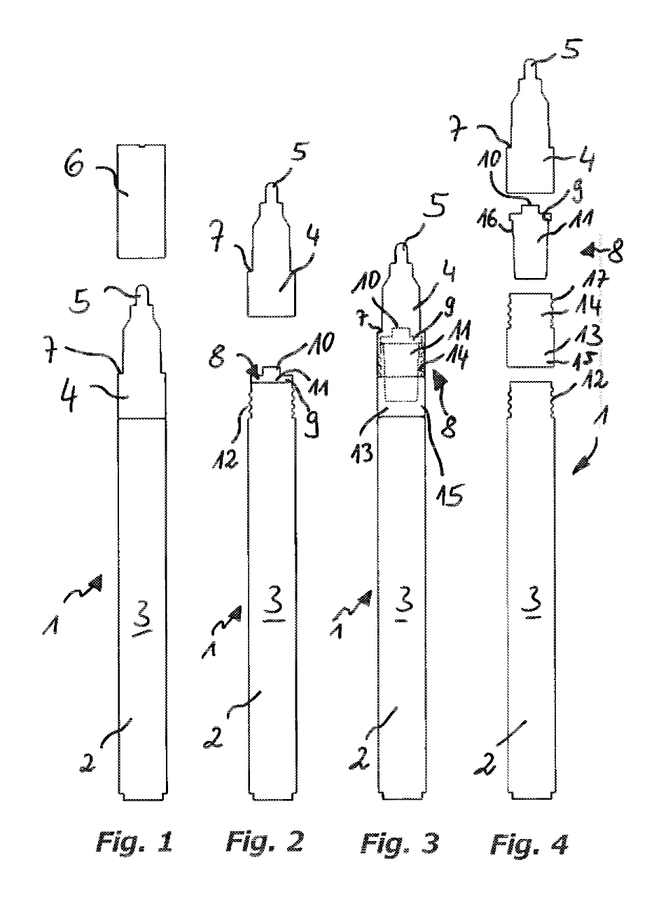

FIGS. 1 and 2 each show an application tool from the prior art given the overall reference 1. Using said application tool 1, it is possible to apply a coating material (not shown in any detail) on a substrate surface (not shown either).

The application tool 1 with a circular cross section has a shaft 2 by which the tool 1 can be gripped, the interior of the shaft forming a reservoir 3 in which the coating material is accommodated. The tool head 4, which is in the operating position in FIG. 1 and has been unscrewed in FIG. 2, can also be seen on the application tool 1, the applicator 5 being located on the end of said tool head remote from the shaft 2, and said applicator being realized as a rounded tip of a lead formed from a fiber material which engages into the interior of the tool head 4 by way of its region remote from the tip. The protective cap 6 associated with the application tool 1 can be seen above the tool head 4, said protective cap, when in position, entering into a plug-in connection with the tool head 4 and abutting against a shoulder 7 of the tool head 4 in its operating position by way of its end-side edge facing the shaft.

In FIG. 2, where the tool head 4 has been detached from the shaft 2, the fact that a valve 8 with valve body 11 is arranged on the end of the shaft 2 facing the tool head 4 can be better seen, with the valve closing the reservoir 3 and when actuated, releasing a quantity of coating material. This occurs by the portion of the applicator 5, which is located inside the tool head and faces the valve 8, engaging into the opening 10 of the valve body 11 and, when pressure is exerted onto the applicator 5 by the shaft, actuating the valve 8. The valve body 11, in its portion facing the tool head 4 and protruding out of the shaft 2, has an annular flange 9 which rests on the end-side edge of the shaft 2 and closes said shaft, a non-visible portion of the valve body 11 forming a driving fit with the inside wall portion of the shaft 2 enclosing it, as a result of which the valve body rests fixedly on the shaft 2. It can also be seen from FIG. 2 that the shaft 2, on its end facing the tool head 4, is provided with an external thread 12 which engages the non-visible internal thread of the tool head 4 in the operating position.

The application tool 1 as claimed in the invention shown in FIGS. 3 and 4 is certainly structurally similar to the application tool in FIGS. 1 and 2, but differs clearly from the former in that a carrier part 13, on which the valve 8 is secured by way of its valve body 11, can be seen arranged between the shaft 2 and the tool head 4 of the application tool 1, and that the carrier part 13 is provided so as to be detachably connectable in each case to the shaft 2 and to the tool head 4 of the tool 1. The carrier part 13 is shown by the broken line in FIG. 3.

In this case, the carrier part 13 accommodates, as can be seen in particular in FIG. 3, the valve body 11 over the substantial part of its longitudinal extension, namely over that part which projects from the annular flange 9 of the valve body 11 in the direction of the shaft 2. This part of the valve body 11 is accommodated completely in the carrier part 13, as can be seen by the bottom edge of the valve body 11 at a spacing above the downwardly turned edge of the carrier part 13 in FIG. 3. In FIGS. 3 and 4, the mentioned annular flange 9 once again forms the end-side upper closure of the carrier part 13, as a result of which the valve 8 is now easily detachable from the shaft 2 by unscrewing the carrier part 13. This can be traced back to the fact that the valve body 11 is now secured on the opening of the sleeve-like carrier part 13 facing the tool head 2 instead of on the shaft opening. This securement is effected in this connection once again by a driving fit which is realized by a portion 16 of the valve body 11 extending slightly in the direction of the annular flange and abutting against it. The carrier part 13 is subdivided essentially into two portions 14, 15, one portion 15 which faces the shaft 2 and has an internal thread and one portion 14 which has an external thread 17 on a cross section which is offset in relation to the cross section of the portion 15. The length of the application tool 1 overall when the carrier part 13 is arranged between the shaft 2 and the tool head 4 is extended by the height of the portion 15 of the carrier part 13.

Instead of the external thread 12 in FIGS. 1 and 2, in the operating position of the carrier part 13 in FIG. 3 its external thread 17 engages the internal thread of the tool head 2, the roll of which is taken on once again by the internal thread (not shown) of the portion 15 of the carrier part, which now engages the external thread 12 of the shaft 2. When the application tool of FIGS. 3 and 4 is being filled, the carrier part 13 can be simply gripped, detached from the shaft 2 and placed down, without this giving rise to fears of negative effects such as contamination.

Accordingly, the above-described invention relates to an application tool 1 for applying a coating material on a substrate surface, said tool having a shaft 2 by which the tool 1 can be gripped and having a reservoir 3 accommodated in the shaft 2 for stocking up with the coating material, wherein the tool 1 is provided with a tool head 4 having an applicator 5, by which the coating material passes onto the surface, and having a valve 8 which is arranged between the reservoir 3 and the tool head 4, and which, when actuated, changes from a closed into an open position and in this latter, outputs a quantity of coating material onto the applicator 5 for application onto the surface. In order to have available an application tool 1 which, on the one hand, reduces the consumption of application tools 1 per se, and, on the other hand, allows for their refilling with a coating material in a reliable and clean manner, a carrier part 13, on which the valve 8 is secured with its valve body 11, is arranged between the shaft 2 and the tool head 4 of the application tool 1, and the carrier part 13 is provided so as to be detachably connectable in each case to the shaft 2 and to the tool head 4 of the tool 1.

1. An application tool for applying a coating material on a substrate surface, said tool comprising a shaft by which the tool can be gripped and having a reservoir accommodated in the shaft for stocking with the coating material, a tool head having an applicator, by which the coating material passes onto the surface, and a valve having a valve body arranged in a carrier part (13) between the reservoir and the tool head, and which, when actuated, changes from a closed into an open position and in the open position, outputs a quantity of coating material onto the applicator for application onto the surface, the carrier part (13), on which the valve (8) is secured, is arranged between the shaft (2) and the tool head (4) of the application tool (1), and the carrier part (13) is provided so as to be detachably connectable in each case to the shaft (2) and to the tool head (4) of the tool (1).

2. The application tool as claimed in claim 1, wherein the carrier part (13) is formed by a sleeve which accommodates the valve body (11) at least over part of a longitudinal extension thereof.

3. The application tool as claimed in claim 1, wherein the valve body (11) forms a rotational body and is provided with an annular flange (9) which covers an opening edge of one end of the carrier part (13) in an operating position of the valve body (11).

4. The application tool as claimed in claim 1, wherein the valve (8) is held on the carrier part (13) by a region of an outer side wall of the valve body (11) forming a driving fit with an inner side wall of the carrier part (13).

5. The application tool as claimed in claim 1, wherein on ends of the carrier part (13) facing the tool head (4) and the shaft (2) of the application tool (1) in each case a connection is provided.

6. The application tool as claimed in claim 1, wherein the carrier part (13) has a region (15) with an internal thread and a region with an external thread (14) along a longitudinal extension thereof.

7. The application tool as claimed in claim 6, wherein the external thread is provided on an offset of an outer wall of the carrier part (13).

8. The application tool as claimed in claim 1, wherein the shaft (2) of the tool (1) has a substantially constant, circular cross section over a longitudinal extension thereof.

9. The application tool as claimed in claim 1, wherein the shaft (2), the carrier part (13) and a region of the tool head (4) facing the carrier part (13) together form a substantially cylindrical contour in an operating position.

10. The application tool as claimed in claim 1, wherein the shaft (2) of the application tool (1) is made from a deflection resistant material.

11. The application tool as claimed in claim 1, wherein the shaft (2) of the application tool (1) is elastic at least in regions in such a manner that it is temporarily deformable by a manually applied pressing force.

12. The application tool as claimed in claim 1, wherein the coating material is provided as a physically drying paint.

13. The application tool as claimed in claim 1, wherein the coating material is a solvent-free paint with an acrylic base.

14. The application tool as claimed in claim 1, wherein the application tool (1) can be provided in a region of the tool head (4) with a protective cap (6) when not in use.

15. A carrier part for an application tool (1) as claimed in claim 1.
